(19) United States
(12) Patent Application Publication
(10) Pub. No.: US 2017/0339965 A1
(43) Pub. Date: Nov. 30, 2017

(54) ASYMMETRICALLY PATTERNED BAKED BREAD FOOD

(71) Applicants: Justin Samuels, Englewood, NJ (US); Samuel Rockwell, Mahwah, NJ (US)

(72) Inventors: Justin Samuels, Englewood, NJ (US); Samuel Rockwell, Mahwah, NJ (US)

(21) Appl. No.: 15/168,768

(22) Filed: May 31, 2016

(51) Int. Cl. A21D 13/00; A47J 37/01

(52) U.S. Cl. CPC A21D 13/00; A47J 37/015

(57) ABSTRACT

An asymmetrical planar bread food product comprising a first baked surface formed in a first pattern and a second baked surface formed in a second pattern different from the first pattern. Preferably, the first pattern is a waffle pattern and the second pattern is a smooth surface. An apparatus for forming a planar bread food product comprises a first baking plate having a first surface formed in a first pattern, a second baking plate opposed to the first baking plate and having a second surface formed in a second pattern different from the first pattern, a first heating element disposed adjacent to the first baking plate, and a second heating element disposed adjacent to the second baking plate, wherein the second surface is off-spaced by a stop from the first surface thereby defining a baking chamber therebetween.

### RELATIONSHIP TO OTHER APPLICATIONS AND PATENTS

The present application is a Continuation-In-Part of a pending U.S. patent application Ser. No. 15/168,768

### TECHNICAL FIELD

This application generally relates to baked bread foods; more particularly to method and apparatus for forming a generally planar bread food baked on both sides; and most particularly to such a planar bread food having a first pattern baked into the surface on a first side. The surface of the second side may comprise any desired baked-in form other than a pattern identical with the first pattern, or none, i.e., the patterning of the two sides is asymmetrical.

### BACKGROUND OF THE INVENTION

In the prior art, a waffle typically is defined as “a crisp cake of batter baked in a waffle iron” (Merriam-Webster), or “a batter cake with a pattern of deep indentations on each side, formed by the gridlike design on each of the two hinged parts of the metal appliance (waffle iron) in which the cake is baked” (Dictionary.com). The gridlike designs are identical. Typically, the indentations are formed to be opposite each other on the two sides and are identical on the two sides with a thin web separating the opposing indentations. Waffles may be formed from a leavened batter or from a dough and typically are consumed by being placed on plates and doused with a sauce or syrup prior to consumption.

U.S. Pat. No. 5,636,564 ('564) disclosing a hinged waffle maker is incorporated herein by reference in its entirety. The disclosed waffle maker has identically-patterned baking irons on its top and bottom heating elements.

US Patent Application Publication No. US 2005/0247210 A1 ('210) disclosing an electric cooking apparatus having removable baking plates is incorporated herein by reference in its entirety. The disclosed cooking apparatus has removable non-identical patterned baking plates on its top and bottom heating elements.

US Patent Application Publication No. 2015/0024107 A1 ('107) discloses method and apparatus for forming a waffle-like product having a baked waffle pattern on one side and a non-baked sliced flat face on the other side. A disclosed method for forming such a waffle-like product comprises the steps of: a) creating waffle dough; b) providing a set of opposed and identical waffle irons having reduced depth recesses from conventional depth recesses; c) heating the opposed waffle irons and the waffle dough therebetween to form an intermediate waffle; and d) slicing the intermediate waffle in an equatorial plane to form a matched set of waffle products each of which comprises one baked patterned waffle face and one opposed non-baked sliced flat face. The disclosed intermediate waffle has relatively shallow indentations and a relatively thick central portion between the opposing indentations to facilitate reliable slicing through the central portion and to provide structural strength to the final mirror-image sliced waffle products.

Each waffle slice, about ½ of the original overall waffle's thickness, can be used to create another new food product—i.e., the slices can be used for a breakfast sandwich (with, e.g., bacon, ham, and egg therebetween); for lunch (for example, a beef burger, turkey burger, a cheese burger, etc.) or a grilled waffle sandwich (cheese between the slices). The opposed pair of minor slices from a single waffle can be consumed by themselves as a treat; or as a meal, used for a sandwich, as a bun, etc., whether consumed for snack, a breakfast, lunch, dinner or dessert sandwich.

Two drawbacks of the resulting matched set of waffle slices are a) that the indentations are substantially shallower than those of a standard waffle; and b) that the flat side formed by slicing through the middle of the intermediate waffle comprises a raw bread surface formed in the central, and therefore least-baked, portion of the intermediate waffle. Toasting of the raw bread surface after slicing and prior to using a waffle slice requires an additional cooking step.

What is needed in the art is an asymmetrically-patterned baked bread food, formed in an asymmetrically-patterned waffle-type iron, and having a waffle pattern baked into at least a portion of the surface on a first side. The surface of the second side may comprise any desired baked-in form other than a pattern identical with the first pattern, or no pattern at all, referred to herein as “non-patterned” or “smooth”.

### SUMMARY OF THE INVENTION

An asymmetrically-patterned baked bread food in accordance with the present invention is formed in an asymmetrically-patterned waffle-type iron apparatus which may be either batch (one or a few baked bread food products baked together) or continuous (a plurality of baked bread food products produced in succession).

The apparatus comprises a first baking plate and a second baking plate off-spaced and oppositely and hingedly arranged from the first baking plate in known fashion for a conventional waffle-iron apparatus. A positive waffle relief pattern is formed in the baking surface of the first baking plate, and a positive second relief pattern is formed in the baking surface of the second baking plate. The positive second relief pattern may comprise any desired form other than a waffle pattern identical with the positive first waffle pattern, or no pattern at all, referred to herein as “non-patterned” or “smooth”.

In operation, the first and second opposed baking plates are heated and an amount of batter or dough is disposed therebetween on one of the baking plates and is allowed to spread laterally therebetween as the hinged first and second baking plates are closed together, thereby filling up both the first and second positive patterns and the space in between as baking begins. After a predetermined time period, the first and second baking plates are separated and the asymmetrically-patterned baked bread food product is removed, ready for use. The product comprises a negative first pattern, preferably a waffle pattern, on a first side and a negative second relief pattern on a second side.

In a currently preferred embodiment, the negative first relief pattern is a waffle pattern, and the second negative relief pattern is a smooth surface.

### BRIEF DESCRIPTION OF THE DRAWINGS

The present invention will now be described, by way of example, with reference to the accompanying drawings, in which:

FIG. 1 is an isometric exploded view from above of a prior art electric cooking apparatus having first and second removable baking plates, substantially as disclosed in the incorporated '210 Publication;

FIG. 2 is an isometric view from above of exemplary first and second removable baking plates in accordance with the present invention, suitable for substitution for the prior art baking plates in the electric cooking apparatus shown in FIG. 1;

FIG. 3 is a plan view of the exemplary first removable baking plate shown in FIG. 2; and

FIG. 4 is an elevational cross-sectional view, taken along line 4-4 in FIG. 3, of an exemplary planar bread food in accordance with the present invention being produced by the apparatus shown in FIGS. 1-3 and having a waffle pattern baked into the surface on a first side and no pattern baked into the surface on a second side.

### DETAILED DESCRIPTION OF THE INVENTION

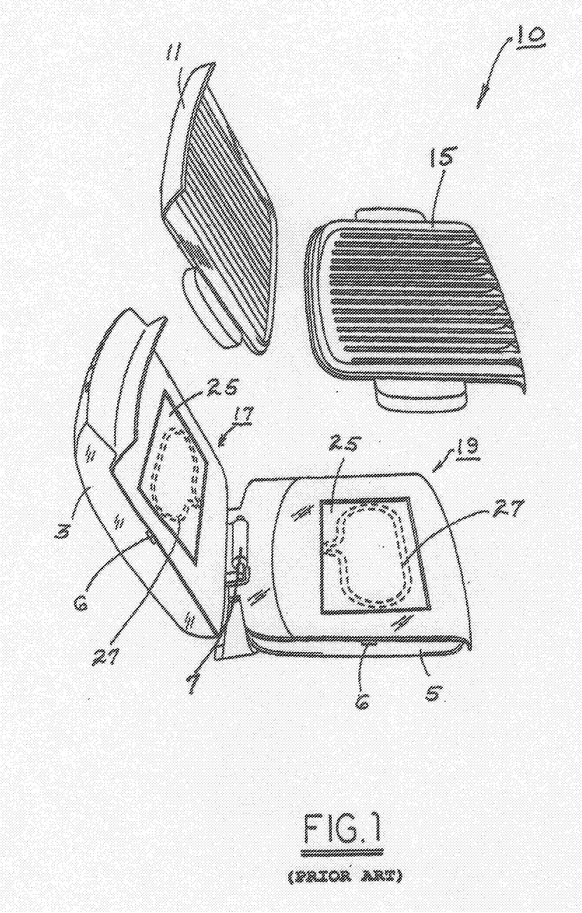

Referring to FIG. 1, a prior art electric cooking apparatus 10 substantially in accordance with US Patent Application Publication No. US 2005/0247210 A1, comprises an upper housing 3 and a lower housing 5 pivotally connected by a hinged connecting unit 7. Lower housing 5 is connected to a power source via a conventional power cord 6, and upper housing 3 is preferably electrically coupled to lower housing 5 via connecting unit 7. Upper housing 3 may include user input controls (not shown) for controlling apparatus 10. Upper housing 3 includes an upper baking plate 11 that is removably attached to upper housing 3. Cooking appliance 10 includes at least one release mechanism operable to remove upper baking plate 11 from upper housing 3. Similarly, lower housing 5 includes a lower baking plate 13 that is removably attached to lower housing 5. Upper baking plate 11, when attached to upper housing 3, is movable relative to lower baking plate 15, from an open position, in which the baking plates are generally perpendicular to each other, to a closed position, in which upper baking plate 11 and lower baking plate 15 form a cooking chamber which, due to the peripheries of the two baking plates overlapping, substantially restrains the escape of vapor therefrom.

Upper and lower baking plates 11,15 may each be provided with an integral heating element, or alternatively may each be provided with a dedicated heating element in close proximity to its respective baking plate.

Upper and lower baking plates 11,15 may form a variety of grilling surfaces. For example, the upper and lower baking plates 11,15 may form a grilling surface having ridges and indentations which are optimized for grilling sandwiches, waffles, toast, steaks, or other types of foodstuffs. For example, in one embodiment, upper and lower baking plates 11,15 may include a waffle-shaped pattern for making waffles or a sandwich-shaped pattern for making sandwiches. In one embodiment, the appliance 10 includes multiple upper plates 11 and multiple lower plates 15, each forming a grilling surface optimized for cooking one type of foodstuffs, as listed above.

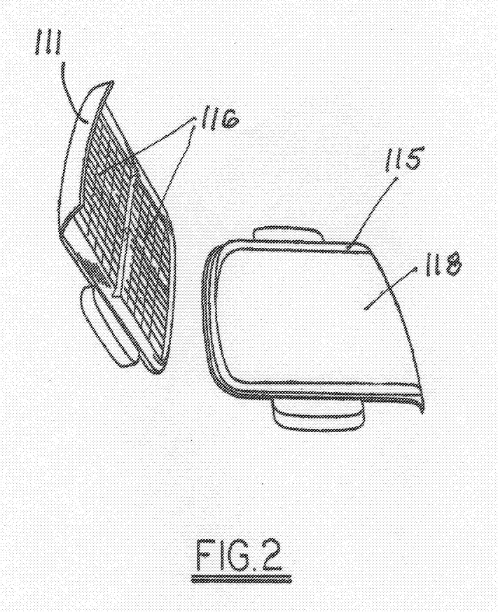

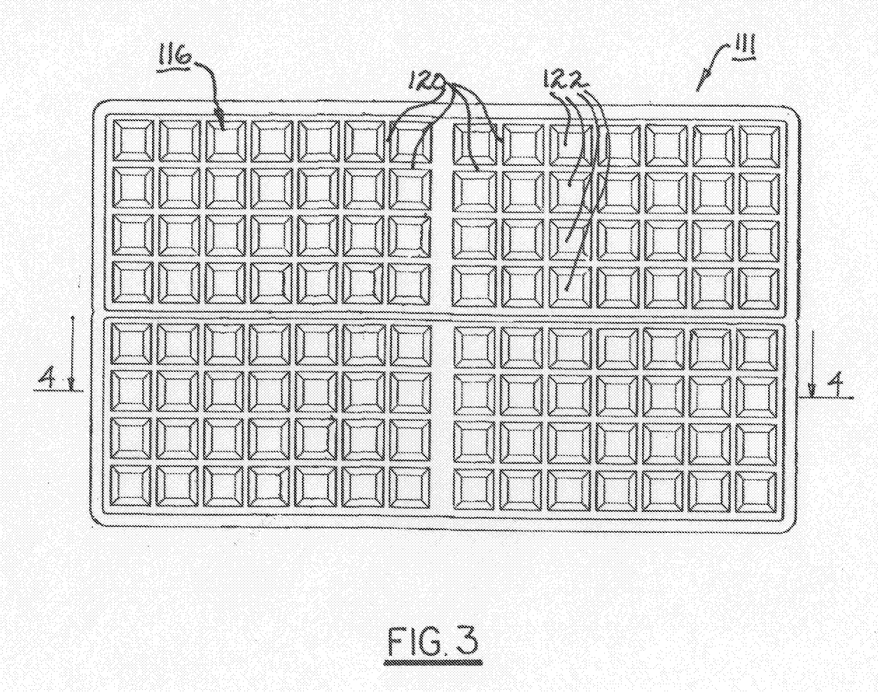

Referring now to FIGS. 2 through 4, exemplary upper and lower plates 111,115 in accordance with the present invention are shown. It should be understood that these plates, adapted for use with the prior art cooking apparatus shown in the FIG. 1 solely, are shown in such removable configuration solely for exemplary purposes. Upper and lower plates in accordance with the present invention otherwise may comprise fixed elements of a hinged apparatus similar to the waffle-maker disclosed in the '564 patent or, alternatively, may comprise elements of a continuous machine similar to a continuous belt-type waffle-maker as is well known in the prior art and need not be described here.

Preferably, plates 111,115 are formed of a metal such as aluminum or stainless steel, and the cooking surfaces may be covered with a release coating formed of, e.g., a fluorocarbon resin.

Upper plate 111 comprises a positive relief pattern 116 formed in the baking surface. Exemplarily, such positive relief pattern may be a waffle pattern comprising a rectangular grid of “valleys” 120 defining therebetween a regular array of upward-protruding “stumps” 122.

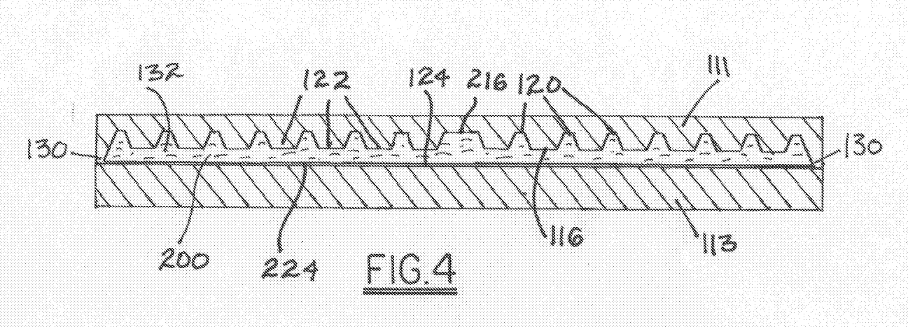

Lower plate 115 comprises a positive relief pattern 124 formed on the baking surface. Pattern 124 may comprise any desired form other than a waffle pattern identical with the positive first waffle pattern 116, or no pattern at all, referred to herein as “non-patterned” or “smooth”. Preferably, pattern 124 is a smooth surface as shown in FIGS. 2 and 4.

Preferably, one or both of upper and lower baking plates 111,115 includes a stop 130 extending above the baking surface, which stop(s) limit the proximity of the baking surfaces of the plates, thereby defining a chamber 132 therebetween for receiving the batter or dough in forming a planar bread food product 200 in accordance with the present invention.

In general, the cooking appliance described herein and shown in FIG. 1, comprising removable plates 111,115 in accordance with the present invention, may be used as follows:

First, the baking plates 111,115 are cleaned, either by hand or in an automatic dishwasher.

Second, a user locks baking plates 111,115 onto the respective housings 3,5 of the cooking appliance.

Third, the cooking appliance may then be powered on and heated up in preparation for cooking.

Fourth, once baking plates 111,115 are heated up, an amount of batter or dough, prepared in accordance with the prior art, is placed on lower baking plate 115, and then covered with upper baking plate 111. Heat is applied via both plates 111,115 to the batter or dough at a predetermined intensity for a predetermined period of time.

Fifth, at the end of the predetermined period of time, the cooking appliance is opened by moving upper housing 3 away from the lower housing 5. The resulting asymmetrically patterned planar bread food 200 may be removed from the appliance.

Asymmetrically patterned planar bread food 200 in accordance with the present invention comprises a baked bread product having a first patterned baked surface 216 that is a negative image of first positive relief pattern 116, and a second patterned baked surface 224 that is a negative image of second positive relief pattern 124.

When it is time to clean the cooking surfaces of the appliance, the user may simply remove the baking plates 111,113, and each plate may be lifted off of its respective housings 113, 115 for cleaning.

What is claimed is:

1. An asymmetrical planar bread food product, comprising:
a first patterned baked surface that is a negative image of a first positive relief pattern in an associated first baking plate, and a second patterned baked surface, that is a negative image of a second positive relief pattern different from said first positive relief pattern in an associated second baking plate,
wherein said first and second patterned baked surfaces have been formed by exposing bread dough directly against said respective first and second positive relief patterns.

2. An asymmetrical planar bread food product in accordance with claim 1 wherein said first positive relief pattern is a waffle pattern.

3. An asymmetrical planar bread food product in accordance with claim 1 wherein said second positive relief pattern is other than a waffle pattern.

4. An apparatus for forming an asymmetrical planar bread food product comprising:
a) a first baking plate having a first surface formed in a first pattern;
b) a second baking plate having a second surface formed in a second pattern different from said first pattern;
c) a first heating element disposed adjacent to said first baking plate; and
d) a second heating element disposed adjacent to said second baking plate,
wherein said second surface is off-spaced from said first surface by at least one stop thereby defining a baking chamber therebetween.

5. An apparatus in accordance with claim 4 wherein said first pattern is a waffle pattern.

6. An apparatus in accordance with claim 4 wherein said second pattern is a smooth surface.

7. An asymmetrical planar bread food product in accordance with claim 1 wherein said second positive relief pattern comprises a smooth surface.
